(19) United States
(12) Patent Application Publication
(10) Pub. No.: US 2025/0013316 A1
(43) Pub. Date: Jan. 9, 2025

(54) Methods of Input and Interaction With an Augmentative and Alternative Communications (AAC) Device

(71) Applicant: Tobii Dynavox AB, Stockholm (SE)

(72) Inventors: Christopher Badman, Solna (SE); Daniel Savhammar, Västerås (SE); Lovisa Braun, Vallentuna (SE); Zoe Kalligiannis, Stockholm (SE); Bethany Diener, Lawrence, KS (US); Royden James, Uppsala (SE); Frederik Engelhardt, Kurravaara (SE); Jaén Cantor, Stockholm (SE); Adil Saeed Khan, Danderyd (SE)

(21) Appl. No.: 18/707,234

(22) PCT Filed: Nov. 8, 2022
(86) PCT No.: PCT/IB2022/060737

§ 371 Date: May 3, 2024

Related U.S. Application Data
(60) Provisional application No. 63/276,835, filed on Nov. 8, 2021.

(51) Int. Cl. G06F 3/023; G06F 3/01; G06F 40/274

(52) U.S. Cl. CPC G06F 3/0237; G06F 3/013; G06F 40/274

(57) ABSTRACT

Provided are methods, systems, and computer program products for using an augmented or alternative communications (AAC) system including an eye tracking device. The method may include receiving at least one gaze input from a user and displaying at least one selected text portion in response to each gaze input. The at least one selected text portion may form a message that is displayed in a message window of the AAC system. A suggested text portion may be generated, the suggested text portion being adaptive to the content of the message and being displayed in the message window with the message. The method may further include receiving a confirmatory gaze input from the user, the confirmatory gaze input causing the suggested text portion to be added to the message.

### CROSS-REFERENCE TO RELATED APPLICATIONS

This application claims priority to U.S. Provisional Patent Application No. 63/276,835 filed Nov. 8, 2021, the disclosure of which is hereby incorporated by reference in its entirety.

### BACKGROUND

### Field of Invention

The present invention relates generally to augmentative and alternative communications (AAC) devices and in some non-limiting embodiments, to methods of input and interaction with AAC devices using eye gaze as an input.

### Discussion of the Related Art

Generally, individuals who rely on eye gaze as an access method for communication are significantly slower when engaging in direct conversation with verbal communicators. This is because the selection of icons (e.g., icons representing letters, words, and phrases) using eye gaze technology to formulate speech is slower than the equivalent using other methods of input.

An eye gaze technology user has to manually select an icon for each letter, word, phrase, or sentence the user wishes to communicate. In many systems, phrases and sentences may be provided to a user based on historical use. Historical phrases and sentences may then be offered to the user for reuse if the system determines that the user is beginning a phrase or sentence in the same way as in a previous formulation. Some systems are populated with pre-set phrases. However, this may be of little benefit to a user as speech use and phraseology can be very personal and therefore the pre-set phrases, whilst suitable for some users, may be unsuitable for others, or may not adequately reflect the personality of the user.

Even where the speech suggestions are considered to be appropriate, the user experience of checking and selecting the suggestions may be sub-optimal. For example, in known systems the text being prepared will be in a first position, with the word or phrase suggestions being offered in selectable form as buttons above or below the sentence being prepared. The user must therefore review the words or phrases being suggested and then, if one is suitable for selection, make the selection, usually by causing their gaze to linger on the button for a predetermined period of time. The relatively large number of options—typically four to six—that are provided to the user, which often refreshes after every additional selection during the formulation, can result in a lot of time spent by the user checking the suggestions for suitability.

During the formulation of speech, it may be necessary to make adaptations or corrections to the sentence or phrase being prepared. This can be a slow and arduous process for the user. In known systems, the user is required to enter an editing mode and to then navigate through the speech text being prepared, for example by using up, down, left, right cursor selection. Whilst this is a simple method of navigation, its use is highly time-consuming when each selection must be made with a gaze input. In some systems, other on-screen buttons can be used to move the cursor forwards and backwards words and/or sentences, but this remains a slow process for the user.

The present disclosure aims to ameliorate or overcome one or more of the above issues.

### SUMMARY

According to some non-limiting embodiments, provided is a method for using augmented or alternative communications (AAC) system including an eye tracking device. In some non-limiting embodiments, the method comprises: receiving, by the eye tracking device, at least one gaze input from a user of the eye tracking device, displaying, via a user interface, at least one selected text portion in response to receiving the at least one gaze input, the at least one selected text portion forming a message, wherein the user interface comprises a message window, and wherein the message is displayed in the message window; generating, by at least one processor, at least one suggested text portion, the at least one suggested text portion being adaptive to a content of the message; displaying, via the user interface, the at least one suggested text portion in the message window of the user interface; receiving, by the eye tracking device, at least one second gaze input from the user; and modifying, by the at least one processor, the message to add the at least one suggested text portion to the message based on receiving the at least one second gaze input from the user.

In some non-limiting embodiments, when receiving the at least one second gaze input, the method may further comprise: determining a location of the at least one suggested text portion in the message window; determining a location of the at least one second gaze input; determining whether the location of the at least one suggested text portion in the message window is the same as the location of the at least one second gaze input; and verifying the at least one second gaze input is a confirmatory input based on determining the location of the at least one suggested text portion in the message window is the same as the location of the gaze input. In some non-limiting embodiments, the method may further comprise: determining whether a length of time of the at least one second gaze input satisfies a threshold value, wherein the threshold value is based on a length of the at least one suggested text portion. In some non-limiting embodiments, when receiving the at least one second gaze input the method may further comprise: displaying a visual indication, indicating that the at least one suggested text portion will be added to the message.

According to some non-limiting embodiments, provided is a method for interacting with a message window in an augmented or alternative communications (AAC) system including an eye tracking device. In some non-limiting embodiments, the method comprises: registering at least one word in a message displayed in a message window as a gazeable region; receiving a gaze input from a user, the gaze input being indicative of the user gazing at the gazeable region of the at least one word; selecting the at least one word associated with the gazeable region in response to receiving the gaze input; presenting at least two navigation buttons to the user, the at least two navigation buttons comprising a backwards navigation button and a forwards navigation button, and each of the at least two navigation buttons being selectable by a user based on the gaze input of the user; wherein selection of at least one navigation button of the at least two navigation buttons results in the system switching between at least three selection states, the at least three selection states comprising: a selection of the at least one word, a cursor being positioned at a beginning of the at least one word, and a cursor being positioned at an end of the at least one word.

In some non-limiting embodiments, when the cursor is positioned at the end of the at least one word and the forwards navigation button is selected, the cursor moves to a beginning of a word following the at least one word in the message. In some non-limiting embodiments, when the cursor is positioned at the beginning of the at least one word and the backwards navigation button is selected, the cursor moves to an end of a word preceding the at least one word in the message. In some non-limiting embodiments, when the at least one word is selected, gaze input of the user on an on-screen keyboard of the AAC system causes replacement of the word. In some non-limiting embodiments, when receiving gaze input from the user gazing at the gazeable region of the at least one word the method may further comprise: displaying a visual indication, wherein the visual indication indicates that the at least one word is going to be selected.

According to non-limiting embodiments, provided is a method for providing suggested text to a user of an augmented or alternative communications (AAC) system. In some non-limiting embodiments, the method comprises: receiving at least one input from a user, displaying a selected text portion in response to receiving the at least one input, the selected text portion forming a message that is displayed in a message window of a user interface; determining a suggested text portion to be suggested to append the selected text portion; and displaying the suggested text portion in the message window; wherein determining the suggested text portion comprises: tokenizing messages previously input by the user from historical messages input by the user to form a database of token sequences, where each token sequence is associated with an instance count indicative of a usage frequency of the token sequence; determining which token sequences in the database include all or a trailing part of the selected text portion; determining a relative strength of the token sequences that include all or a trailing part of the selected text portion; and outputting a token sequence as the suggested text portion if the token sequence has a sufficient relative strength.

In some non-limiting embodiments, when determining a relative strength of the token sequences the method may comprise: determining a length of the token sequences; and determining the relative strength of the token sequence based on the length of the token sequences. In some non-limiting embodiments, when determining the suggested text portion the method may comprise: determining an addressee of the user; and determining the suggested text portion based on the addressee of the user. In some non-limiting embodiments, determining the addressee of the user is based on voice recognition. In some non-limiting embodiments, when determining the suggested text portion the method may comprise: determining a context of the message; and determining the suggested text portion based on the context of the message.

According to some non-limiting embodiments, provided is a system for using augmented or alternative communications (AAC) system including an eye tracking device. In some non-limiting embodiments, the system comprises at least one processor programmed or configured to: receive at least one gaze input from a user of the eye tracking device, display at least one selected text portion in response to receiving the at least one gaze input, the at least one selected text portion forming a message, wherein the user interface comprises a message window, and wherein the message is displayed in the message window; generate at least one suggested text portion, the at least one suggested text portion being adaptive to a content of the message; display the at least one suggested text portion in the message window of the user interface; receive at least one second gaze input from the user; and modify the message to add the at least one suggested text portion to the message based on receiving the at least one second gaze input from the user.

In some non-limiting embodiments, when receiving the at least one second gaze input, the at least one processor may be programmed or configured to: determine a location of the at least one suggested text portion in the message window; determine a location of the at least one second gaze input; determine whether the location of the at least one suggested text portion in the message window is the same as the location of the at least one second gaze input; and verify the at least one second gaze input is a confirmatory input based on determining the location of the at least one suggested text portion in the message window is the same as the location of the gaze input. In some non-limiting embodiments, the at least one processor may be further programmed or configured to: determine whether a length of time of the at least one second gaze input satisfies a threshold value, wherein the threshold value is based on a length of the at least one suggested text portion. In some non-limiting embodiments, when receiving the at least one second gaze input the at least one processor may be further programmed or configured to: display a visual indication, indicating that the at least one suggested text portion will be added to the message.

In some non-limiting embodiments, provided is a system for interacting with a message window in an augmented or alternative communications (AAC) system including an eye tracking device, the system comprising at least one processor programmed or configured to: register at least one word in a message displayed in a message window as a gazeable region; receive a gaze input from a user, the gaze input being indicative of the user gazing at the gazeable region of the at least one word; select the at least one word associated with the gazeable region in response to receiving the gaze input; present at least two navigation buttons to the user, the at least two navigation buttons comprising a backwards navigation button and a forwards navigation button, and each of the at least two navigation button being selectable by a user based on the gaze input of the user; wherein selection of at least one navigation button of the at least two navigation buttons results in the system switching between at least three selection states, the at least three selection states comprising: a selection of the at least one word, a cursor being positioned at a beginning of the at least one word, and a cursor being positioned at an end of the at least one word.

In some non-limiting embodiments, when the cursor is positioned at the end of the at least one word and the forwards navigation button is selected, the cursor moves to a beginning of a word following the at least one word in the message. In some non-limiting embodiments, when the cursor is positioned at the beginning of the at least one word and the backwards navigation button is selected, the cursor moves to an end of a word preceding the at least one word in the message. In some non-limiting embodiments, when the at least one word is selected, gaze input of the user via an on-screen keyboard may cause replacement of the word. In some non-limiting embodiments, when receiving gaze input from the user gazing at the gazeable region of the at least one word, the at least one processor may be further programmed or configured to: display a visual indication, wherein the visual indication indicates that the at least one word is going to be selected.

In some non-limiting embodiments, provided is a system for providing suggested text to a user of an augmented or alternative communications (AAC) system. In some non-limiting embodiments, the system comprising at least one processor programmed or configured to: receive at least one input from a user, display a selected text portion in response to the at least one input receive from the user, the selected text portion forming a message that is displayed in a message window of a user interface; determine a suggested text portion to be suggested to append the selected text portion; and display the suggested text portion in the message window; wherein when determining the suggested text portion, the at least one processor is programmed or configured to: tokenize previously input messages from historical messages input by the user to form a database of token sequences, where each token sequence is associated with an instance count indicative of a usage frequency of the token sequence; determine which token sequences in the database include all or a trailing part of the selected text portion; determine a relative strength of the token sequences that include all or a trailing part of the selected text portion; and output a token sequence as the suggested text portion if the token sequence has a sufficient relative strength.

In some non-limiting embodiments, when determining a relative strength of the token sequences the at least one processor may be programmed or configured to: determine a length of the token sequences; and determine the relative strength of the token sequence based on the length of the token sequences. In some non-limiting embodiments, when determining the suggested text portion the at least one processor may be programmed or configured to: determine an addressee of the user; and determine the suggested text portion based on the addressee of the user. In some non-limiting embodiments, determining the addressee of the user may be based on voice recognition. In some non-limiting embodiments, when determining the suggested text portion the at least one processor may be programmed or configured to: determine a context of the message; and determine the suggested text portion based on the context of the message.

In some non-limiting embodiments, provided is a computer program product for using augmented or alternative communications (AAC) system including an eye tracking device. In some non-limiting embodiments, the computer program product may comprise at least one non-transitory computer-readable medium including one or more instructions that, when executed by at least one processor, cause the at least one processor to: receive at least one gaze input from a user of the eye tracking device, display at least one selected text portion in response to receiving the at least one gaze input, the at least one selected text portion forming a message, wherein the user interface comprises a message window, and wherein the message is displayed in the message window; generate at least one suggested text portion, the at least one suggested text portion being adaptive to a content of the message; display the at least one suggested text portion in the message window of the user interface; receive at least one second gaze input from the user; and modify the message to add the at least one suggested text portion to the message based on receiving the at least one second gaze input from the user.

In some non-limiting embodiments, when receiving the at least one second gaze input, the one or more instructions may cause the at least one processor to: determine a location of the at least one suggested text portion in the message window; determine a location of the at least one second gaze input; determine whether the location of the at least one suggested text portion in the message window is the same as the location of the at least one second gaze input; and verify the at least one second gaze input is a confirmatory input based on determining the location of the at least one suggested text portion in the message window is the same as the location of the gaze input. In some non-limiting embodiments, the one or more instructions may further cause the at least one processor to: determine whether a length of time of the at least one second gaze input satisfies a threshold value, wherein the threshold value is based on a length of the at least one suggested text portion. In some non-limiting embodiments, when receiving the at least one second gaze input the one or more instructions may further cause the at least one processor to: display a visual indication, indicating that the at least one suggested text portion will be added to the message.

In some non-limiting embodiments, provided is a computer program product for interacting with a message window in an augmented or alternative communications (AAC) system including an eye tracking device. In some non-limiting embodiments, the computer program product may comprise at least one non-transitory computer-readable medium including one or more instructions that, when executed by at least one processor, cause the at least one processor to: register at least one word in a message displayed in a message window as a gazeable region; receive a gaze input from a user, the gaze input being indicative of the user gazing at the gazeable region of the at least one word; select the at least one word associated with the gazeable region in response to receiving the gaze input; present at least two navigation buttons to the user, the at least two navigation buttons comprising a backwards navigation button and a forwards navigation button, and each of the at least two navigation button being selectable by a user based on the gaze input of the user; wherein selection of at least one navigation button of the at least two navigation buttons results in the AAC system switching between at least three selection states, the at least three selection states comprising: a selection of the at least one word, a cursor being positioned at a beginning of the at least one word, and a cursor being positioned at an end of the at least one word.

In some non-limiting embodiments, when the cursor is positioned at the end of the at least one word and the forwards navigation button is selected, the cursor may move to a beginning of a word following the at least one word in the message. In some non-limiting embodiments, when the cursor is positioned at the beginning of the at least one word and the backwards navigation button is selected, the cursor may move to an end of a word preceding the at least one word in the message. In some non-limiting embodiments, when the at least one word is selected, gaze input of the user via an on-screen keyboard may cause replacement of the word. In some non-limiting embodiments, when receiving gaze input from the user gazing at the gazeable region of the at least one word the one or more instructions may further cause the at least one processor to: display a visual indication, wherein the visual indication indicates that the at least one word is going to be selected.

In some non-limiting embodiments, provided is a computer program product for providing suggested text to a user of an augmented or alternative communications (AAC) system. In some non-limiting embodiments, the computer program product may comprise at least one non-transitory computer-readable medium including one or more instructions that, when executed by at least one processor, cause the at least one processor to: receive at least one input from a user, display a selected text portion in response to the at least one input received from the user, the selected text portion forming a message that is displayed in a message window of a user interface; determine a suggested text portion to be suggested to append the selected text portion; and display the suggested text portion in the message window; wherein when determining the suggested text portion, the one or more instructions cause the at least one processor to: tokenize previously input messages from historical messages input by the user to form a database of token sequences, where each token sequence is associated with an instance count indicative of a usage frequency of the token sequence; determine which token sequences in the database include all or a trailing part of the selected text portion; determine a relative strength of the token sequences that include all or a trailing part of the selected text portion; and output a token sequence as the suggested text portion if the token sequence has a sufficient relative strength.

In some non-limiting embodiments, when determining a relative strength of the token sequences the one or more instructions may cause the at least one processor to: determine a length of the token sequences; and determine the relative strength of the token sequence based on the length of the token sequences. In some non-limiting embodiments, when determining the suggested text portion the one or more instructions may cause the at least one processor to: determine an addressee of the user; and determine the suggested text portion based on the addressee of the user. In some non-limiting embodiments, determining the addressee of the user may be based on voice recognition. In some non-limiting embodiments, when determining the suggested text portion the one or more instructions may cause the at least one processor to: determine a context of the message; and determine the suggested text portion based on the context of the message.

Other non-limiting embodiments or aspects will be set forth in the following numbered clauses:

Clause 1: A method of input for using augmented or alternative communications (AAC) system including an eye tracking device, the method comprising: receiving, by the eye tracking device, at least one gaze input from a user of the eye tracking device, displaying, via a user interface, at least one selected text portion in response to receiving the at least one gaze input, the at least one selected text portion forming a message, wherein the user interface comprises a message window, and wherein the message is displayed in the message window; generating, by at least one processor, at least one suggested text portion, the at least one suggested text portion being adaptive to a content of the message; displaying, via the user interface, the at least one suggested text portion in the message window of the user interface; receiving, by the eye tracking device, at least one second gaze input from the user; and modifying, by the at least one processor, the message to add the at least one suggested text portion to the message based on receiving the at least one second gaze input from the user.

Clause 2: The method of clause 1, wherein when receiving the at least one second gaze input, the method further comprises: determining a location of the at least one suggested text portion in the message window; determining a location of the at least one second gaze input; determining whether the location of the at least one suggested text portion in the message window is the same as the location of the at least one second gaze input; and verifying the at least one second gaze input is a confirmatory input based on determining the location of the at least one suggested text portion in the message window is the same as the location of the gaze input.

Clause 3: The method of clause 1 or clause 2, further comprising: determining whether a length of time of the at least one second gaze input satisfies a threshold value, wherein the threshold value is based on a length of the at least one suggested text portion.

Clause 4: The method of any of clauses 1-3, wherein receiving the at least one second gaze input further comprises: displaying a visual indication, indicating that the at least one suggested text portion will be added to the message.

Clause 5: A method for interacting with a message window in an augmented or alternative communications (AAC) system including an eye tracking device, the method comprising: registering at least one word in a message displayed in a message window as a gazeable region; receiving a gaze input from a user, the gaze input being indicative of the user gazing at the gazeable region of the at least one word; selecting the at least one word associated with the gazeable region in response to receiving the gaze input; presenting at least two navigation buttons to the user, the at least two navigation buttons comprising a backwards navigation button and a forwards navigation button, and each of the at least two navigation buttons being selectable by a user based on the gaze input of the user; wherein selection of at least one navigation button of the at least two navigation buttons results in the system switching between at least three selection states, the at least three selection states comprising: a selection of the at least one word, a cursor being positioned at a beginning of the at least one word, and a cursor being positioned at an end of the at least one word.

Clause 6: The method of clause 5, wherein, when the cursor is positioned at the end of the at least one word and the forwards navigation button is selected, the cursor moves to a beginning of a word following the at least one word in the message.

Clause 7: The method of clause 5 or clause 6, wherein, when the cursor is positioned at the beginning of the at least one word and the backwards navigation button is selected, the cursor moves to an end of a word preceding the at least one word in the message.

Clause 8: The method of any of clauses 5-7, wherein, when the at least one word is selected, gaze input of the user on an on-screen keyboard of the AAC system causes replacement of the word.

Clause 9: The method of any of clauses 5-8, wherein receiving gaze input from the user gazing at the gazeable region of the at least one word further comprises: displaying a visual indication, wherein the visual indication indicates that the at least one word is going to be selected.

Clause 10: A method for providing suggested text to a user of an augmented or alternative communications (AAC) system, the method comprising: receiving at least one input from a user, displaying a selected text portion in response to receiving the at least one input, the selected text portion forming a message that is displayed in a message window of a user interface; determining a suggested text portion to be suggested to append the selected text portion; and displaying the suggested text portion in the message window; wherein determining the suggested text portion comprises: tokenizing previously input messages from historical messages input by the user to form a database of token sequences, where each token sequence is associated with an instance count indicative of a usage frequency of the token sequence; determining which token sequences in the database include all or a trailing part of the selected text portion; determining a relative strength of the token sequences that include all or a trailing part of the selected text portion; and outputting a token sequence as the suggested text portion if the token sequence has a sufficient relative strength.

Clause 11: The method of clause 10, wherein determining a relative strength of the token sequences comprises: determining a length of the token sequences; and determining the relative strength of the token sequence based on the length of the token sequences.

Clause 12: The method of clause 10 or clause 11, wherein determining the suggested text portion comprises: determining an addressee of the user; and determining the suggested text portion based on the addressee of the user.

Clause 13: The method of any of clauses 10-12, wherein determining the addressee of the user is based on voice recognition.

Clause 14: The method of any of clauses 10-13, wherein determining the suggested text portion comprises: determining a context of the message; and determining the suggested text portion based on the context of the message.

Clause 15: A system for using augmented or alternative communications (AAC) system including an eye tracking device, the system comprising at least one processor programmed or configured to: receive at least one gaze input from a user of the eye tracking device, display at least one selected text portion in response to receiving the at least one gaze input, the at least one selected text portion forming a message, wherein the user interface comprises a message window, and wherein the message is displayed in the message window; generate at least one suggested text portion, the at least one suggested text portion being adaptive to a content of the message; display the at least one suggested text portion in the message window of the user interface; receive at least one second gaze input from the user; and modify the message to add the at least one suggested text portion to the message based on receiving the at least one second gaze input from the user.

Clause 16. The system of clause 15, wherein when receiving the at least one second gaze input, the at least one processor is programmed or configured to: determine a location of the at least one suggested text portion in the message window; determine a location of the at least one second gaze input; determine whether the location of the at least one suggested text portion in the message window is the same as the location of the at least one second gaze input; and verify the at least one second gaze input is a confirmatory input based on determining the location of the at least one suggested text portion in the message window is the same as the location of the gaze input.

Clause 17: The system of clause 15 or clause 16, wherein the at least one processor is further programmed or configured to: determine whether a length of time of the at least one second gaze input satisfies a threshold value, wherein the threshold value is based on a length of the at least one suggested text portion.

Clause 18: The system of any of clauses 15-17, wherein when receiving the at least one second gaze input the at least one processor is further programmed or configured to: display a visual indication, indicating that the at least one suggested text portion will be added to the message.

Clause 19: A system for interacting with a message window in an augmented or alternative communications (AAC) system including an eye tracking device, the system comprising at least one processor programmed or configured to: register at least one word in a message displayed in a message window as a gazeable region; receive a gaze input from a user, the gaze input being indicative of the user gazing at the gazeable region of the at least one word; select the at least one word associated with the gazeable region in response to receiving the gaze input; present at least two navigation buttons to the user, the at least two navigation buttons comprising a backwards navigation button and a forwards navigation button, and each of the at least two navigation button being selectable by a user based on the gaze input of the user; wherein selection of at least one navigation button of the at least two navigation buttons results in the system switching between at least three selection states, the at least three selection states comprising: a selection of the at least one word, a cursor being positioned at a beginning of the at least one word, and a cursor being positioned at an end of the at least one word.

Clause 20: The system of clause 19, wherein, when the cursor is positioned at the end of the at least one word and the forwards navigation button is selected, the cursor moves to a beginning of a word following the at least one word in the message.

Clause 21: The system of clause 19 or clause 20, wherein, when the cursor is positioned at the beginning of the at least one word and the backwards navigation button is selected, the cursor moves to an end of a word preceding the at least one word in the message.

Clause 22: The system of any of clauses 19-21, wherein, when the at least one word is selected, gaze input of the user via an on-screen keyboard causes replacement of the word.

Clause 23: The system of any of clauses 19-22, wherein when receiving gaze input from the user gazing at the gazeable region of the at least one word the at least one processor is further programmed or configured to: display a visual indication, wherein the visual indication indicates that the at least one word is going to be selected.

Clause 24: A system for providing suggested text to a user of an augmented or alternative communications (AAC) system, the system comprising at least one processor programmed or configured to: receive at least one input from a user, display a selected text portion in response to the at least one input received from the user, the selected text portion forming a message that is displayed in a message window of a user interface; determine a suggested text portion to be suggested to append the selected text portion; and display the suggested text portion in the message window; wherein when determining the suggested text portion, the at least one processor is programmed or configured to: tokenize previously input messages from historical messages input by the user to form a database of token sequences, where each token sequence is associated with an instance count indicative of a usage frequency of the token sequence; determine which token sequences in the database include all or a trailing part of the selected text portion; determine a relative strength of the token sequences that include all or a trailing part of the selected text portion; and output a token sequence as the suggested text portion if the token sequence has a sufficient relative strength.

Clause 25: The system of clause 24, wherein when determining a relative strength of the token sequences the at least one processor is programmed or configured to: determine a length of the token sequences; and determine the relative strength of the token sequence based on the length of the token sequences.

Clause 26: The system of clause 24 or clause 25, wherein when determining the suggested text portion the at least one processor is programmed or configured to: determine of an addressee of the user; and determine the suggested text portion based on the addressee of the user.

Clause 27: The system of any of clauses 24-26, wherein determining the addressee of the user is based on voice recognition.

Clause 28: The system of any of clauses 24-27, wherein when determining the suggested text portion the at least one processor is programmed or configured to: determine a context of the message; and determine the suggested text portion based on the context of the message.

Clause 29: A computer program product for using augmented or alternative communications (AAC) system including an eye tracking device, the computer program product comprising at least one non-transitory computer-readable medium including one or more instructions that, when executed by at least one processor, cause the at least one processor to: receive at least one gaze input from a user of the eye tracking device, display at least one selected text portion in response to receiving the at least one gaze input, the at least one selected text portion forming a message, wherein the user interface comprises a message window, and wherein the message is displayed in the message window; generate at least one suggested text portion, the at least one suggested text portion being adaptive to a content of the message; display the at least one suggested text portion in the message window of the user interface; receive at least one second gaze input from the user; and modify the message to add the at least one suggested text portion to the message based on receiving the at least one second gaze input from the user.

Clause 30: The computer program product of clause 29, wherein when receiving the at least one second gaze input, the one or more instructions cause the at least one processor to: determine a location of the at least one suggested text portion in the message window; determine a location of the at least one second gaze input; determine whether the location of the at least one suggested text portion in the message window is the same as the location of the at least one second gaze input; and verify the at least one second gaze input is a confirmatory input based on determining the location of the at least one suggested text portion in the message window is the same as the location of the gaze input.

Clause 31: The computer program product of clause 29 or clause 30, wherein the one or more instructions further cause the at least one processor to: determine whether a length of time of the at least one second gaze input satisfies a threshold value, wherein the threshold value is based on a length of the at least one suggested text portion.

Clause 32: The computer program product of any of clauses 29-31, wherein when receiving the at least one second gaze input the one or more instructions further cause the at least one processor to: display a visual indication, indicating that the at least one suggested text portion will be added to the message.

Clause 33: A computer program product for interacting with a message window in an augmented or alternative communications (AAC) system including an eye tracking device, the computer program product comprising at least one non-transitory computer-readable medium including one or more instructions that, when executed by at least one processor, cause the at least one processor to: register at least one word in a message displayed in a message window as a gazeable region; receive a gaze input from a user, the gaze input being indicative of the user gazing at the gazeable region of the at least one word; select the at least one word associated with the gazeable region in response to receiving the gaze input; present at least two navigation buttons to the user, the at least two navigation buttons comprising a backwards navigation button and a forwards navigation button, and each of the at least two navigation button being selectable by a user based on the gaze input of the user; wherein selection of at least one navigation button of the at least two navigation buttons results in the AAC system switching between at least three selection states, the at least three selection states comprising: a selection of the at least one word, a cursor being positioned at a beginning of the at least one word, and a cursor being positioned at an end of the at least one word.

Clause 34: The computer program product of clause 33, wherein, when the cursor is positioned at the end of the at least one word and the forwards navigation button is selected, the cursor moves to a beginning of a word following the at least one word in the message.

Clause 35: The computer program product of clause 33 or clause 34, wherein, when the cursor is positioned at the beginning of the at least one word and the backwards navigation button is selected, the cursor moves to an end of a word preceding the at least one word in the message.

Clause 36: The computer program product of any of clauses 33-35, wherein, when the at least one word is selected, gaze input of the user via an on-screen keyboard causes replacement of the word.

Clause 37: The computer program product of any of clauses 33-36, wherein when receiving gaze input from the user gazing at the gazeable region of the at least one word the one or more instructions further cause the at least one processor to: display a visual indication, wherein the visual indication indicates that the at least one word is going to be selected.

Clause 38: A computer program product for providing suggested text to a user of an augmented or alternative communications (AAC) system, the computer program product comprising at least one non-transitory computer-readable medium including one or more instructions that, when executed by at least one processor, cause the at least one processor to: receive at least one input from a user, display a selected text portion in response to the at least one input received from the user, the selected text portion forming a message that is displayed in a message window of a user interface; determine a suggested text portion to be suggested to append the selected text portion; and display the suggested text portion in the message window; wherein when determining the suggested text portion, the one or more instructions cause the at least one processor to: tokenize previously input messages from historical messages input by the user to form a database of token sequences, where each token sequence is associated with an instance count indicative of a usage frequency of the token sequence; determine which token sequences in the database include all or a trailing part of the selected text portion; determine a relative strength of the token sequences that include all or a trailing part of the selected text portion; and output a token sequence as the suggested text portion if the token sequence has a sufficient relative strength.

Clause 39: The computer program product of clause 38, wherein when determining a relative strength of the token sequences the one or more instructions cause the at least one processor to: determine a length of the token sequences; and determine the relative strength of the token sequence based on the length of the token sequences.

Clause 40: The computer program product of clause 38 or clause 39, wherein when determining the suggested text portion, the one or more instructions cause the at least one processor to: determine an addressee of the user; and determine the suggested text portion based on the addressee of the user.

Clause 41: The computer program product of any of clauses 38-40, wherein determining the addressee of the user is based on voice recognition.

Clause 42: The computer program product of any of clauses 38-41, wherein when determining the suggested text portion the one or more instructions cause the at least one processor to: determine a context of the message; and determine the suggested text portion based on the context of the message.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is an exemplary schematic view of an AAC system in accordance with a non-limiting embodiment of the present disclosure;

FIGS. 2-5 depict exemplary interaction windows for a communications application running on the AAC system of FIG. 1, showing a non-limiting embodiments of a phrase prediction and selection feature according to the present disclosure;

FIG. 6 is a flow chart of a non-limiting embodiment of a phrase prediction suggestion feature;

FIGS. 7 and 8 are exemplary interaction windows for a communications application running on the AAC system of FIG. 1, showing a non-limiting embodiments of a word selection and editing feature according to the present disclosure; and

FIG. 9 is an exemplary state diagram of a non-limiting embodiment of a word selection feature of the present disclosure.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices that are configured to directly or indirectly communicate with or over one or more networks. The computing device may be a mobile device. In other non-limiting embodiments or aspects, the computing device may be a desktop computer, a server, a group of servers, or other non-mobile computer. Furthermore, the term “computer” may refer to any computing device that includes the necessary components to receive, process, and output data, and normally includes a display, a processor, a memory, an input device, and a network interface. The term “interface” may refer to a generated display, such as one or more graphical user interfaces (GUIs) with which a user may interact, either directly or indirectly (e.g., through an eye tracking device, a keyboard, a mouse, etc.).

As used herein, the terms “eye tracking device” may refer to one or more electronic devices configured to receive, capture, and/or process data (e.g., gaze data). An eye tracking device may, in some examples, may include a camera, image sensor(s) (e.g., complementary metal oxide semiconductor (CMOS) sensors, charged coupled device (CCD) sensors, and/or the like), and/or lights. An eye tracking device, in some examples, may be part of (e.g., integrated into) a computing device. Alternatively, an eye tracking device may be an accessory for a computing device. An eye tracking device may, in some examples, include the necessary components to receive, process, and output data, such as a processor, a display, a memory, an input device, a network interface, and/or the like.

As used herein, the term “system” may refer to one or more computing devices or combinations of computing devices such as, but not limited to, processors, servers, client devices, software applications, and/or other like components.

Provided are methods, systems, and computer program products for using augmented or alternative communications (AAC) system including an eye tracking device. In some non-limiting embodiments, the method may include: receiving, by the eye tracking device, at least one gaze input from a user of the eye tracking device; displaying, via a user interface, at least one selected text portion in response to receiving the at least one gaze input, the at least one selected text portion forming a message, wherein the user interface comprises a message window, and wherein the message is displayed in the message window; generating, by at least one processor, at least one suggested text portion, the at least one suggested text portion being adaptive to a content of the message; displaying, via the user interface, the at least one suggested text portion in the message window of the user interface; receiving, by the eye tracking device, at least one second gaze input from the user; and modifying, by the at least one processor, the message to add the at least one suggested text portion to the message based on receiving the at least one second gaze input from the user. In some non-limiting embodiments, wherein when receiving the at least one second gaze input, the method may include: determining a location of the at least one suggested text portion in the message window; determining a location of the at least one second gaze input; determining whether the location of the at least one suggested text portion in the message window is the same as the location of the at least one second gaze input; and verifying the at least one second gaze input is a confirmatory input based on determining the location of the at least one suggested text portion in the message window is the same as the location of the gaze input. In some non-limiting embodiments, the method may include: determining whether a length of time of the at least one second gaze input satisfies a threshold value, wherein the threshold value is based on a length of the at least one suggested text portion. In some non-limiting embodiments, when receiving the at least one second gaze input the method may include: displaying a visual indication, indicating that the at least one suggested text portion will be added to the message.

Additionally, provided are systems, methods, and computer program products for interacting with a message window in an augmented or alternative communications (AAC) system including an eye tracking device. In some non-limiting embodiments or aspects the method may include: registering at least one word in a message displayed in a message window as a gazeable region; receiving a gaze input from a user, the gaze input being indicative of the user gazing at the gazeable region of the at least one word; selecting the at least one word associated with the gazeable region in response to receiving the gaze input; presenting at least two navigation buttons to the user, the at least two navigation buttons comprising a backwards navigation button and a forwards navigation button, and each of the at least two navigation button being selectable by a user based on the gaze input of the user; wherein selection of at least one navigation button of the at least two navigation buttons results in the system switching between at least three selection states, the at least three selection states comprising: a selection of the at least one word, a cursor being positioned at a beginning of the at least one word, and a cursor being positioned at an end of the at least one word. In some non-limiting embodiments, when the cursor is positioned at the end of the at least one word and the forwards navigation button is selected, the cursor may move to a beginning of a word following the at least one word in the message. In some non-limiting embodiments, when the cursor is positioned at the beginning of the at least one word and the backwards navigation button is selected, the cursor may move to an end of a word preceding the at least one word in the message. In some non-limiting embodiments, when the at least one word is selected, gaze input of the user on an on-screen keyboard of the AAC system causes replacement of the word. In some non-limiting embodiments, when receiving gaze input from the user gazing at the gazeable region of the at least one word the method may include: displaying a visual indication, wherein the visual indication indicates that the at least one word is going to be selected.

Additionally, provided are systems, methods, and computer program products for providing suggested text to a user of an augmented or alternative communications (AAC) system. In some non-limiting embodiments, the method may include: receiving at least one input from a user, displaying a selected text portion in response to receiving the at least one input, the selected text portion forming a message that is displayed in a message window of a user interface; determining a suggested text portion to be suggested to append the selected text portion; and displaying the suggested text portion in the message window; wherein determining the suggested text portion comprises: tokenizing previously input messages from historical messages input by the user to form a database of token sequences, where each token sequence is associated with an instance count indicative of a usage frequency of the token sequence; determining which token sequences in the database include all or a trailing part of the selected text portion; determining a relative strength of the token sequences that include all or a trailing part of the selected text portion; and outputting a token sequence as the suggested text portion if the token sequence has a sufficient relative strength. In some non-limiting embodiments, when determining a relative strength of the token sequences the method may include: determining a length of the token sequences; and determining the relative strength of the token sequence based on the length of the token sequences. In some non-limiting embodiments, when determining the suggested text portion the method may include: determining an addressee of the user; and determining the suggested text portion based on the addressee of the user. In some non-limiting embodiments, determining the addressee of the user may be based on voice recognition. In some non-limiting embodiments, when determining the suggested text portion the method may include: determining a context of the message; and determining the suggested text portion based on the context of the message.

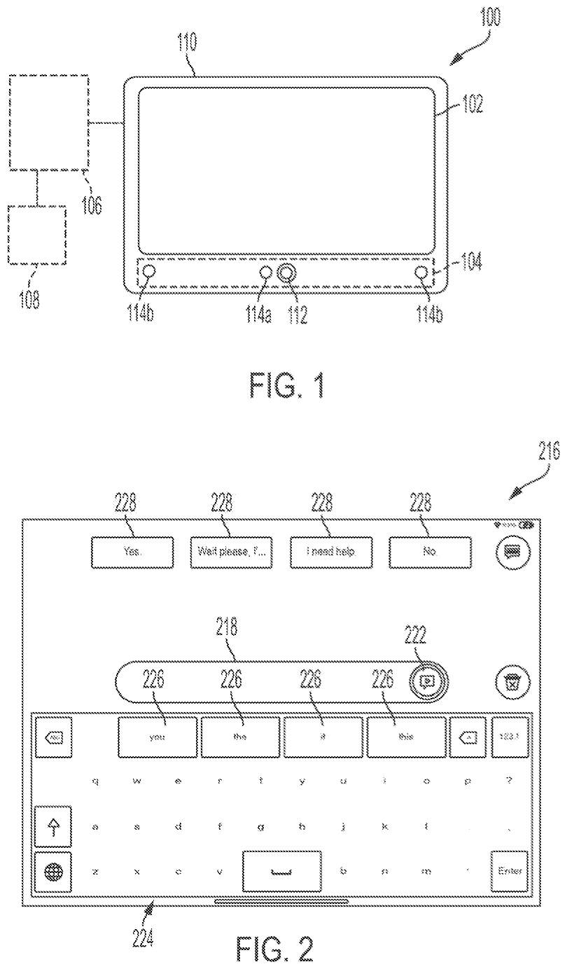

FIG. 1 shows a non-limiting embodiment of an augmentative and alternative communications (AAC) system 100. In some non-limiting embodiments, the AAC system 100 may include a display 102 of a computing device, an eye tracking device 104, processor 106, and/or memory 108. In some non-limiting embodiments, the computing device, display 102, and/or eye tracking device 104 may interconnect (e.g., establish a connection to communicate) via wired connections, wireless connections, or a combination of wired and wireless connections. In some non-limiting embodiments, AAC system 100 may include a communication network (not shown). In some non-limiting embodiments, AAC system 100 may include one or more computing devices configured to communicate via the communication network.

In some non-limiting embodiments or aspects, display 102 may be part of and/or connected to (e.g., via a wireless or wired connection) the computing device. For example, display 102 may be a screen of the computing device. In some non-limiting embodiments or aspects, display 102 may display data via a user interface. The user interface may be a graphical user interface (GUI). For example, display 102 may display data associated with a communications application (e.g., AAC application), a user input, and/or an output via the GUI. In some non-limiting embodiments, the GUI may be an interactive GUI. For example, the interactive GUI may be configured to update based on receiving an input from the user. In some non-limiting embodiments, the interactive GUI may be configured to receive, as an input, a selection of an icon or button from the user (e.g., using eye gaze) of the GUI and/or text from the user (e.g., using eye gaze) via an input box of the GUI.

In some non-limiting embodiments, the computing device may communicate with eye tracking device 104, processor, 106, and/or memory 108 via a wired or wireless connection. In some non-limiting embodiments, processor 106 and/or memory 108 may be internal and/or external to the computing device.

In some non-limiting embodiments, eye tracking device 104 may receive an input (e.g., gaze data) from the user. For example, eye tracking device 104 may receive the input from the user via camera 112. Eye tracking device 104 may be configured to capture, process, and/or track the gaze data of the user to provide gaze-based inputs to the AAC system 100. For example, eye tracking device 104 may provide the gaze data to the computing device, processor 106, and/or memory 108 via a wire or wireless connection.

In some non-limiting embodiments, the processor 106 and/or memory 108 may communicate with the eye tracking device 104 and/or the computing device. The processor 106 and memory 108 are depicted schematically for the sake of clarity in FIG. 1, but may generally be comprised within a housing 110 of the AAC system 100. In some non-limiting embodiments, the processor 106 and/or memory 108 may be in a separate, remote unit (e.g., a separate computing device) or computer system. Similarly, whilst the eye tracking device 104 is shown as being positioned in the housing 110 with the display 102, in other embodiments the eye tracking device 104 may be positioned differently, in a separate housing, or may be, for example, provided as a peripheral component. In some non-limiting embodiments, the computing device may be positioned in the housing 110.

In some non-limiting embodiments, the eye tracking device 104 may include a camera 112 and/or a plurality of illuminators 114a, 114b. For example, the camera 112 may be configured to point towards the eyes of the user viewing the display 102 of the computing device, along with three illuminators 114a, 114b. In some non-limiting embodiments, at least one of the plurality of illuminators 114a, 114b may be a bright pupil (BP) illuminator. For example, illuminator 114a may be a BP illuminator. In some non-limiting embodiments, BP illuminator 114a may be situated adjacent to the camera 112 such that, when illuminated the BP illuminator 114a may cause a bright pupil effect on images captured by the camera 112. In some non-limiting embodiments, at least one of the plurality of illuminators 114a, 114b may be a dark pupil (DP) illuminator. For example, illuminators 114b may be dark pupil (DP) illuminators. In some non-limiting embodiments, DP illuminators 114b may be positioned toward the edges of the housing 110, away from the camera 112, to provide a DP effect when images are captured by the camera 112 when DP illuminators 114b are illuminated.

In some non-limiting embodiments, the AAC system 100 may be used by a user to collect eye tracking data (e.g., gaze data) of the user, hereon referred to as “gaze inputs”. The gaze inputs may be used to interact with the AAC system 100 to provide commands to the communications application (e.g., AAC application) provided on the AAC system 100, which may be stored in the memory 108 and operated by the processor 106. For example, The AAC system 100 may receive the gaze inputs, process the gaze inputs, and/or communicate an output based on the gaze inputs. In some non-limiting embodiments, eye tracking device 104 may receive and/or capture gaze inputs from a user of eye tracking device 104. In some non-limiting embodiments, the gaze inputs may be associated with at least one user command. In some non-limiting embodiments, an output of the AAC system 100 may include an audible output via a speaker (not shown), such as speech from the speaker, and/or a visual output via display 102.

Referring now to FIG. 2, FIG. 2 shows an exemplary interaction window 216 for a communications application (e.g., AAC application) run by AAC system 100. The interaction window 216 may be a user interface displayed via display 102 of the AAC system 100 when the communications application is being used. In some non-limiting embodiments, interaction window 216 may include a message window 218, within which data associated with a message being composed by a user may be displayed. In some non-limiting embodiments, interaction window 216 may include a speech button 222, on the right of the message window 218, which, upon selection, may cause the AAC system 100 to audibly communicate (e.g., via a speaker) a message contained within the message window 218.

In some non-limiting embodiments, interaction window 216 may include a keyboard 224. For example, keyboard 224 may appear below the message window 218. Keyboard 224 may be configured to receive an input from a user. For example, a user may compose a message within the message window 218 by selecting selectable buttons on keyboard 224. In some non-limiting embodiments, keyboard 224 operates like known on-screen keyboards, with a gaze input operating the buttons. In some non-limiting embodiments, a button of keyboard 224 may be selected by a user when the gaze of the user lingers (e.g., pauses for a predetermined period of time) over a button of keyboard 224. Other known methods of activating and confirming buttons using gaze data may also be used.

In some non-limiting embodiments, interaction window 216 may include a plurality of word prediction buttons 226. For example, data associated with a plurality of word prediction buttons 226 may be displayed between the keyboard 224 and the message window 218. In some non-limiting embodiments, the word prediction buttons 226 may include complete words. In some non-limiting embodiments, the words appearing on word prediction buttons 226 may adapt (e.g., change) based on the content of the message window 218 and/or the message history of the user, which may be stored in the memory 108. In this way, the word prediction buttons 226 offer full words to the user in order to avoid them having to type out each individual letter of every word. As seen in FIGS. 2-5, a total of four-word prediction buttons 226 may be displayed, but a greater or lesser number may instead be used. In some non-limiting embodiments, four, five, or six word prediction buttons 226 may be present, providing the user with four, five, or six options for their next word.

In some non-limiting embodiments, interaction windown 216 may include a plurality of quick message buttons 228. In some non-limiting embodiments, data associated with a plurality of quick message buttons 228 may be displayed at a top of interaction window 216. In some non-limiting embodiments, each of the plurality of quick message buttons 228 may display data associated with a unique response message. In some non-limiting embodiments, at least one of the plurality of quick message buttons may be selected by a user (e.g., using eye gaze) to automatically provide data associated with the at least one selected quick message button 228. In contrast to selecting data associated with a letter using the keyboard 224 and/or selecting data associated with a predicted word using the word prediction buttons 226, selecting at least one of the plurality of quick message buttons 228 may result in the AAC system 100 instantly outputting a message contained in the at least one quick message button 228 that has been selected by the user. In some non-limiting embodiments, a single gaze input may be required to audibly play (e.g., via a speaker) data associated with a message displayed in at least one of the plurality of quick message buttons 228.

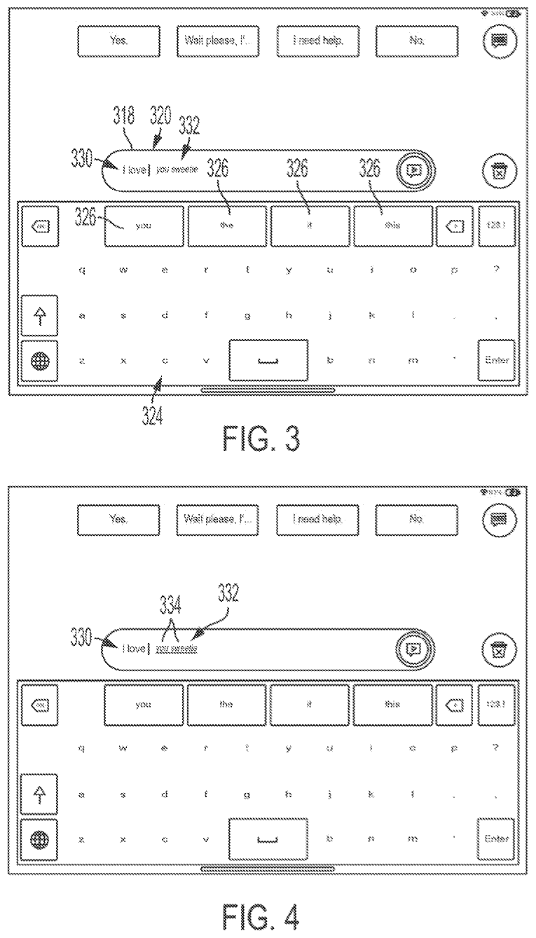

FIGS. 3-5 show exemplary instances of using AAC system 100. As shown in FIG. 3, a user may compose a message 320 in the message window 318. The message 320 may be composed using the on-screen keyboard 324, via gaze inputs received from the user. In some non-limiting embodiments, dwell-based selection may be used to confirm a gaze input of the user, i.e., the user must dwell on each button for a predetermined, system-defined, period of time before the input related to the button is reflected in the message window 318. This prevents and/or limits inputting incorrect and/or inaccurate gaze inputs by the user. Other forms of gaze input confirmation, such as switch-based confirmation, may also be used where appropriate.

As shown in FIG. 3, inputs received from the user may be displayed via display 102 as text in selected text portion 330. For example, as seen in FIG. 3, the inputs from the user have resulted in the text shown in black, reading “I love”, displayed in selected text portion 330. In response to the user inputs, the AAC system 100 may provided a suggestion as to the content that the user may wish to add to the message 320. For example, AAC system 100 may provide suggested text portion 332. The suggested text portion 332 may be displayed in a different color (e.g., grey text), as seen in FIG. 3. In other embodiments, the suggested text portion 332 may be differentiated from the selected text portion 330 in any other way, such as a difference in: color, font, format, and/or any other feature that may differentiate two adjacent portions of text on a display. In some non-limiting embodiments, the suggested text portion 332 is provided to the user in a manner that is easily visible during the normal use of the keyboard 324 and message window 318. For example, the suggested text portion 332 may be situated adjacent to the selected text portion 330 in the message window 318, allowing the user to review the suggested text portion 332 and determine whether the suggested text portion 332 is desired for inclusion in the message 320 being composed in the message window 318.

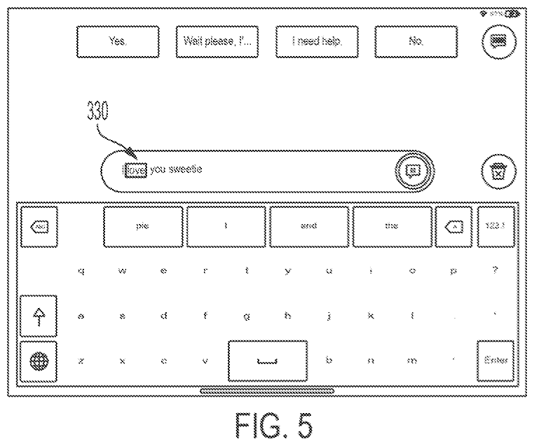

In some non-limiting embodiments, if the user determines that the suggested text portion 332 is appropriate for inclusion in the message 320 being composed, the user may then choose to select the suggested text portion 332 in order that it transitions from being suggested to being a part of the message 320, along with the selected text portion 330 that was composed using the keyboard 324 or word prediction buttons 326. In some non-limiting embodiments, selection of the suggested text portion 332 may be accomplished by having the user dwell their gaze over the suggested text portion 332 in the message window 318 for a predetermined period of time. In some non-limiting embodiments, once the eye tracking device 104 has determined that the user has been gazing at the suggested text portion 332 for the predetermined period of time, the suggested text portion 332 will be made a part of the message 320, as is shown in FIG. 5.

In some non-limiting embodiments, it may be desirable for the user to make a selection by dwelling their gaze directly on the suggested text portion 332 within the message window 318, in which case the gazeable area for causing a transition of the suggested text portion to a part of the message 320 may be limited to an area including the suggested text portion 332 and, if desirable, an area immediately surrounding the suggested text portion 332. This may prevent or limit the chance of accidental selection of the suggested text portion 332. In some non-limiting embodiments, the gazeable area may be selected such that it encompasses any or all of the text within the message window 318, or any or all of the message window 318 itself.

In some non-limiting embodiments, when the user is in the process of selecting the suggested text portion 332, i.e., when they are gazing at the gazeable area, the user may receive feedback from AAC system 100 indicating to the user that the suggested text portion 332 will be selected if their gaze continues to linger over the gazeable area. In some non-limiting embodiments, such feedback may be provided visually to the user via display 102.

An example of visual feedback being provided is shown in FIG. 4, as the gaze of the user lingers over a gazeable area surrounding the suggested text portion, the visual indication may be displayed via display 102. For example, the visual indication may be a series of two underlines 334 under the text of the suggested text portion 332. In some non-limiting embodiments, underlines 334 may begin as dots and extend together until underlines 334 join to form a single underline 334. In some non-limiting embodiments, the time at which underlines 334 join to form a single underline 334 may correspond to the predetermined period of time and/or the selection of the suggested text portion 332. In some non-limiting embodiments, the visual indication may provide the user with the knowledge that they are gazing in the correct position to select the suggested text portion 332. In some non-limiting embodiments, the visual indication may provide a user with knowledge as to approximately how much time remains before suggested text portion 332 is selected.

In some non-limiting embodiments, the visual indicator, may be, a single underline or a differently shaped marker of some kind. In some non-limiting embodiments, the indication of progression of the period for selection may also be a change in shape or size of the visual indicator or a change in colour, thickness, and/or another visual characteristic.

Referring again to FIG. 3, the suggested text portion 332 is shown as a portion of text that continues after the selected text portion 330—“I love”—with a two-word phrase—“you sweetie”. In some non-limiting embodiments, the suggested text portion 332 provides the user with a single suggestion in the message window for at least one further word to form the message 320. Unlike known AAC systems, which commonly use message history to provide word prediction buttons 326 such as those shown below the message window 318 or to suggest entire sentences that have been used historically, the AAC system 100 disclosed herein may use a learning algorithm to provide phrase suggestions that are not only suitable for the continuation of the message 320, but are tailored to the user's historical use of language.

Whilst known systems do take into account the content of previously composed messages in order to provide suggestions that match specific entire messages that have been composed in the past, the present disclosure uses semantic analysis in order to provide more intelligent suggestions that are related to messages that the user has previously composed but which need not be identical. For example, if the user tends to use particular phrases, word combinations, or clauses, then these phrases, word combinations, or clauses may be suggested where it would make semantic sense, even where the user has not previously composed an identical message. By taking into account the semantic history of the user, the AAC system 100 can provide individualised suggestions that are likely to be desirable, without relying on the use of full strings of text that have previously been composed.

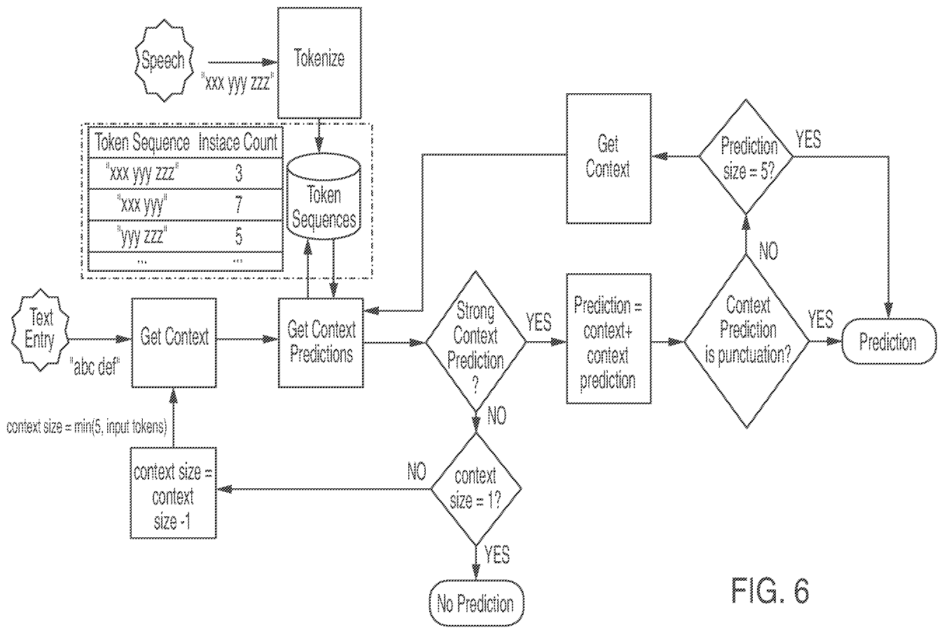

In some non-limiting embodiments, the present invention may assign a weight to different portions of text composed by the user. For example, the different portions of text composed by the user may be assigned a weight based on taking into account the user's natural formulaic language. The phrase with the highest weight may be suggested in the message window 318 when the user starts to type the message. The process of assigning a weight to a portion of the text is described in relation to FIG. 6.

In some non-limiting embodiments, all previously input messages 320, or “speech” is tokenized, and any speech input by the user is split into its constituent parts of sequences. For example, if the user has input a message 320 with three words in the order “xxx yyy zzz”, when tokeninzing the message, AAC system 100 may split the message into parts or “token sequences”. For example, AAC system 100 may split the message into three token sequences where: “xxx yyy zzz” is the complete message; “xxx yyy” is a first part of the message; and “yyy zzz” is a second part of the message.

In some non-limiting embodiments, the tokenizing process may include tallying a total number of uses for each token sequence for a number of previous messages 320 written by the user. As shown in FIG. 6, the token sequence “xxx yyy zzz” has been used a total of three times, the token sequence “xxx yyy” has been used a total of seven times, and the token sequence “yyy zzz” has been used a total of five times. In some non-limiting embodiments, the token sequence may be stored in the memory 108. In some non-limiting embodiments, the tallying may be much more varied than just the three token sequences shown in FIG. 6. For example, the tallying may comprise a plurality of different combinations of words used in a plurality of messages, wherein each message has a message size of a plurality of message sizes. In some non-limiting embodiments, the stored token sequences may provide an indication of the word combinations that are used most often by the user, over a period of time. In some non-limiting embodiments, over the period of time, the token sequences used may be built up into a large database stored in the memory 108, the database being representative of how the user uses language, with an instance count associated with each token sequence, the instance count being representative of the number of times that particular token sequence has been recorded in the messages 320 entered by the user.

In some non-limiting embodiments, the token sequences may include any combination of words in any position in the message 320. For example, if a four-word phrase is entered as a message 320 then one token sequence may include all four words, two token sequences may include three words, three token sequences may include two words, etc. Each token sequence may be at the beginning of the message 320, end of the message 320, or at any position between the beginning and the end of the message 320. The “first part”, “second part” notation used above serves only to distinguish the parts of the message being referred to in the present embodiment. In some non-limiting embodiments, each token sequence may be identified in the system by its constituent words or by another unique identifier such as a number that can be linked to the particular word combination through a look-up table.

In some non-limiting embodimensts, AAC system 100 may generate a user profile for the user which may be stored in memory 108. Token sequence database may be individual to each user, and it is therefore desirable to link each database of token sequences to a user profile of the AAC system 100. Therefore, a user may login to the AAC system 100 or select a user profile and subsequent text entry will result in phrase predictions that reflects the previous language use of that particular user. In some non-limiting embodiments, AAC system 100 may associate the token sequence database for the user with the user profile for the user stored in memory 108.

The specific operation of the phrase prediction feature will now be described with reference to a single user, but it will be clear that the described processes will be operable for each individual user, with data stored separately such that each user has an individual token sequence database that accurately reflects their speech.

In some non-limiting embodiments, when the user begins to input text, the newly input text and/or the selected text portion 330 may be compared to the database of token sequences stored in the memory 108. The aim of the comparison is to find token sequences that contain the entirety of the selected text portion 330 or a trailing part of it. For example, if the user has entered the words “I love to”, the algorithm may then find all token sequences in the database that include “I love to” and also all token sequences that include “love to” and “to”. In some non-limiting embodiments, each of the token sequences found may be compared to see if any have a substantially greater instance count in the database than others to which they are being compared.

It will be apparent that shorter token sequences, i.e., those which are constituent parts of longer token sequences, will always have an equal or greater instance count than those token sequences of which they are a constituent part. For example, considering the phase “I love to win”, it is impossible for the entire token sequence “I love to win” to have a higher instance count than its constituent “I love”. In order to provide the best phrase prediction to the user, it may therefore be desirable to provide a weighting to the consideration of the instance counts of the token sequences that takes into account the otherwise inevitable bias towards the suggestion of shorted phrases.

In some non-limiting embodiments, the determination of the relative suitability of a token sequence over other possible token sequences, in the context of the message being written, is as a strength of the context prediction. This relative suitability may be determined by asking, algorithmically, whether the token sequence that has a greatest instance count is ‘strong enough’ compared to the token sequence with a second greatest instance count, to accept as a prediction, and therefore to provide as a suggested text portion. In some non-limiting embodiments, if the answer is “no”, the token sequence is not strong enough compared to its nearest competitor—the second-placed token sequence by instance count—then no suggested text portion is output by the system. In order to take into account the length of the token sequences, and to avoid bias towards shorter token sequences, the strength required to output a token sequence as a suggested text portion may vary based on the length of the token sequence. This may be referred to as a strength modifier.

As an example, if the token sequence with the greatest instance count has two words, then the algorithm may require the token sequence to have a five-times greater instance count than the token sequence with the second greatest instance count in order for the token sequence to be considered “strong”. This determination is made as part of the “strong context prediction?” step in FIG. 6. Conversely, if the token sequence with the greatest instance count has four words, then it may only require a two-times greater instance count than the token sequence with the second greatest instance count in order to be considered “strong”. The strength modifier may of course take any value form, with those included here simply used to help describe, and not being limiting to the invention.

The algorithm can further be adapted to avoid bias to shorter token sequences by specifically looking for longer token sequences, and only looking for shorter token sequences if it is determined that a longer token sequence is not strong enough to be suggested. The algorithm may therefore be adapted to only look for token sequences of a certain length—say, four words—and therefore to determine the strength of the four-word token sequence with the largest instance count compared to the four-word token sequence with the second largest instance count. If it is determined that the largest instance count is, to use the previous strength modifier, twice as large, then the four-word token sequence may be selected. If, on the other hand, the strength is not great enough, then the algorithm may then proceed to look at three-word token sequences. The top two three-word token sequences can then be compared, and if strong enough, the one with the largest instance count will be selected, and if not, the system will consider two word token sequences.

If the cycle continues with no token sequence being strong enough, the outcome may be that no token sequence is considered to be strong enough, and therefore no suggested text portion will be output.

In some non-limiting embodiments, the longest token sequence stored in the database may be five words in length. In some non-limiting embodiments, the shortest length of token sequence may be two words in length. Either of these limitations may be changed by the designer of the particular system and should not be considered limiting to the invention.

It should be noted that the “length” of the token sequence is the length of the token sequence including the parts of the selected text portion that are included in the token sequence. For example, if the selected text portion, input by the user already, is “I love to” and the “strong” prediction from the algorithm is “love to go running”, then even through the suggested text portion will just be “go running”, this is considered to be a token length of four words “love to go running”.

In some non-limiting embodiments, it may also be desirable to make suggestions based on the addressee to whom the user is addressing the messages. In some non-limiting embodiments, the AAC system 100 may therefore include a microphone that can receive voice inputs from the addressee and use these voice inputs to perform speaker recognition. Speaker recognition can allow the AAC system 100 to adapt the suggested text portion to take into account not only the message history of the user but also the addressee to whom the message is addressed. For example, the user may communicate with a first addressee in a different way than with a second addressee. In some non-limiting embodiments, it may also or alternatively be possible to identify the addressee manually through an input from the user, such as selecting the addressee who is being communicated with from an additional menu on the AAC system 100.

To give a specific example, the user may be inclined to use more formal language, vocabulary, and/or phrasing when communicating with colleagues and more colloquial or informal language, vocabulary, and/or phrasing when communicating with friends. Speaker recognition—i.e., the determination of whom the user is addressing—can therefore be used to automatically adapt the suggested text portion to at least partially be based upon the addressee.

In some non-limiting embodiments, the database of token sequences may be unique not only to each user but to each pairing of user and addressee. The AAC system 100 may therefore determine the user, for example through use of a user profile, and the addressee, through voice recognition. The messages used in conversation between each pairing can then be stored in a database that is then only accessed for message suggestions when this pairing is in conversation. Databases will therefore exist that corresponds to other pairings, each database only being utilised for speech suggestions when the pairing is detected by or selected on the system.

In some non-limiting embodiments, a database for the user may be modified by use of an additional weighting or modifier that operates to adjust the suggestions. For example, token sequences that are used in a greater frequency with a particular addressee can be assigned a modifier that makes them more likely to be selected with that addressee than when the AAC system 100 is being used with a different addressee.

With any of these systems, the modifiers may, for example, take into account not just the user and addressee, but also the context of the conversation. This can be achieved by using contextual analysis to note when specific token sequences are used in the context of a conversation in general. For example, a user may commonly use a different set of token sequences when they are discussing sports than when they are discussing politics. This can be reflected in weightings or modifiers applied to the token sequences. By monitoring the context of the usage of specific token sequences, the system may therefore act to provide a further improved suggested text portion that is suitable for the context and addressee.

In some situations, the user may make mistakes in the message being composed. In known systems, the solution is either to delete all the letters and words that have been composed after the mistake, in order to correct the mistake, or to open a separate menu that provides a number of gaze-selectable buttons that allow the user to navigate a cursor to the position of the mistake in order to make a correction. Neither of these solutions are particularly user-friendly as they require a lot of gaze inputs, each of which necessitates a dwell time, making the process for correction a lengthy one. The present invention provides an improved method of correcting mistakes in a message being composed.

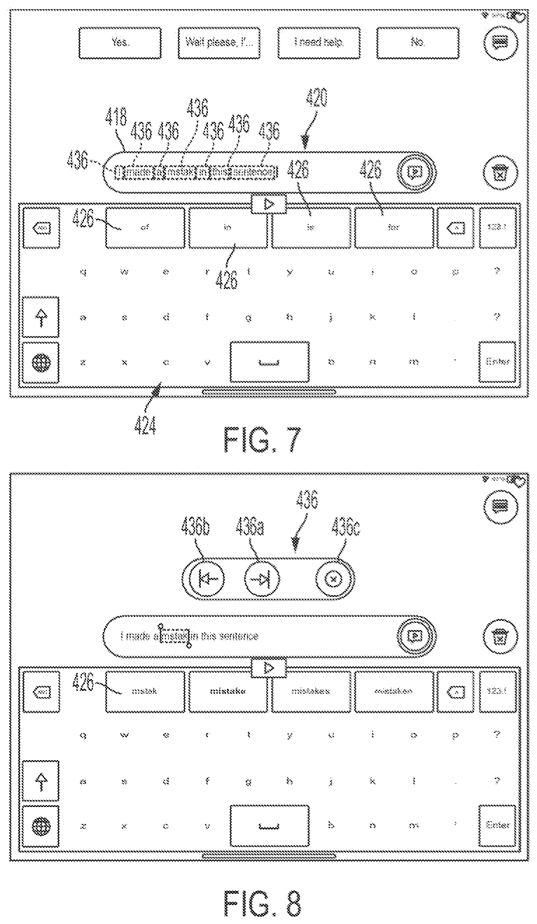

FIG. 7 shows a message 420 that has been composed in a message window 418 of the AAC system 100. The message has a spelling error in the fourth word, where “mstak” is included in the message 420 instead of the intended word “mistake”. It is therefore necessary for the user to be able to correct this error. The depicted embodiment therefore provides a plurality of gaze-selectable areas 434 through which the user may interact with the composed message 420. The gaze-selectable areas 434 are visualised in FIG. 7 as a plurality of dotted boxes surrounding the words of the message 420. However, in this embodiment the gaze-selectable areas 434 will not be visualised on the display 102 and will instead just be understood by the user to be present. Of course, in other embodiments, it may be desirable to visualise the gaze-selectable areas 434 by showing these boxes on screen, for example, or by use of other visual indications.

The user can therefore select the word they wish to correct by causing their gaze to dwell on the word “mstak”. The dwell time may be set as any threshold, and such a determination may for example be changed by the user in the settings of the AAC system 100.

In the embodiment shown, two things happen as a result of the user dwelling over the word “mstak”: the word becomes highlighted, showing that it has been selected, and a selection menu 436, consisting of three buttons 436a, 436b, 436c, appears above the message window. The three buttons 436a, 436b, 436c, which are gaze-selectable, provide three simple actions to the user: forwards, backwards, and cancel. The cancel button 436c removes the selection from the message window 418, closes the selection menu 436 and returns the system to the previous state. The backward button 436b, identified by the arrow pointing to the left, and the forward button 436a, identified by the arrow pointing to the right, operate to move the selection between words and between states, which will now be discussed in more detail.

Rather than simply causing the cursor to step through individual letters of words, the present invention seeks to provide an enhanced method by which the user can move through the message 420 in a more intelligent manner. In cases where touch or keyboard inputs are used, the number of key presses required to move a cursor to a specific position may not be particularly important, however, where gaze input is being used, each button selection takes a much greater length of time, depending on the particular dwell period being used, and therefore limiting the number of button selections is highly desirable. The depicted embodiment therefore cycles through three different states: word selection, word end, and word beginning.

In the word selection state, the cursor shows the word to have been selected by the user, as in FIG. 8. The selection is shown by highlighting with a start cursor and an end cursor visualising the beginning and end points of the highlighting, but other methods of visualising this information may additionally or alternatively be used. When in the word selection state, the user may replace the word using the word prediction buttons 426, which offer up a number of alternative words, which may be based upon predictions made through prior user message history or via a spellchecking function, for example. Alternatively, the user may choose to input a word by direct use of the on-screen keyboard 424. Such interactions, in the selection state, will result in the original highlighted word being replaced by whichever input the user chooses.

From the word selection state, the selection of the backward button 436b will result in the highlighting being removed and the cursor moving to the beginning of the word that was previously selected, i.e., being placed in a word beginning state. The same options for inputs will be available to the user, but the result of these interactions will be slightly different. For example, use of a word prediction button 426 will result in the word suggested by the button being inserted before the cursor, and use of the keyboard 424 will result in the letter or symbol being inserted in the place at which the cursor is positioned.

From the word beginning state, the selection of the backward button 436b will result in the cursor moving to the end of the preceding word, i.e., being placed in a word end state. The same options for inputs will be available to the user, but the results of these interactions will be slightly different. For example, use of a word prediction button 426 will result in the word suggested by the button being inserted after the cursor, and use of the keyboard 424 will result in the letter or symbol being inserted in the place at which the cursor is positioned.

From the word end state, the selection of the backward button 436b will result in the cursor moving to select the preceding word, and thus being placed in the word selection state. In the example of FIG. 7, this will result in the highlighting of the word “a”.

From the word selection state, the selection of the forward button 436a will result in the highlighting being removed and the cursor moving to the end of the word that was previously selected, i.e., being placed in a word end state. The same options for inputs will be available to the user, but the result of these interactions will be slightly different. For example, use of a word prediction button 426 will result in the word suggested by the button being inserted after the cursor, and use of the keyboard 424 will result in the letter or symbol being inserted in the place at which the cursor is positioned.

From the word end state, the selection of the forward button 436a will result in the cursor moving to the beginning of the following word, i.e., being placed in a word beginning state. The same options for inputs will be available to the user, but the results of these interactions will be slightly different. For example, use of a word prediction button 426 will result in the word suggested by the button being inserted before the cursor, and use of the keyboard 424 will result in the letter or symbol being inserted in the place at which the cursor is positioned.

From the word beginning state, the selection of the forward button 436a will result in the cursor moving to select the following word, and thus being placed in the word selection state. In the example of FIGS. 7 and 8, this will result in the highlighting of the word “in”.

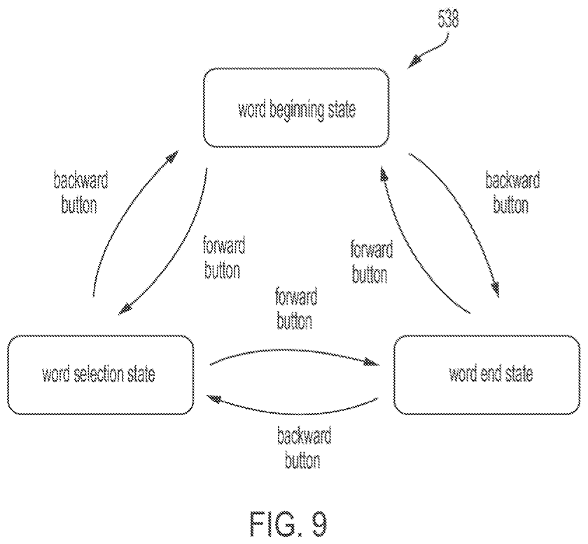

Of course, the user may use the forward button 436a and backward button 436b in any combination in order to move forwards or backwards to select any word in the message or to position the cursor at the beginning or end of any word in the message 420. A state machine 538 depicting this is shown in FIG. 9.

By operation of the selection menu 436, and subsequent operation of the keyboard 424 or word prediction buttons 426, the user is provided with a simple and time-saving method of editing messages 420 without requiring unnecessary repetition of button selections to move the cursor one space or character at a time. The allowance of selection of a particular word in the message window 418 simply by looking at the gaze-selectable area 434 surrounding the word also allows the user to quickly advance the word selection to a particular position.

1. A method of input for using augmented or alternative communications (AAC) system including an eye tracking device, the method comprising:
receiving, by the eye tracking device, at least one gaze input from a user of the eye tracking device,
displaying, via a user interface, at least one selected text portion in response to receiving the at least one gaze input, the at least one selected text portion forming a message, wherein the user interface comprises a message window, and wherein the message is displayed in the message window;
generating, by at least one processor, at least one suggested text portion, the at least one suggested text portion being adaptive to a content of the message;
displaying, via the user interface, the at least one suggested text portion in the message window of the user interface;
receiving, by the eye tracking device, at least one second gaze input from the user; and
modifying, by the at least one processor, the message to add the at least one suggested text portion to the message based on receiving the at least one second gaze input from the user.

2. The method of claim 1, wherein when receiving the at least one second gaze input, the method further comprises:
determining a location of the at least one suggested text portion in the message window;
determining a location of the at least one second gaze input;
determining whether the location of the at least one suggested text portion in the message window is the same as the location of the at least one second gaze input; and
verifying the at least one second gaze input is a confirmatory input based on determining the location of the at least one suggested text portion in the message window is the same as the location of the gaze input.

3. The method of claim 2, further comprising: determining whether a length of time of the at least one second gaze input satisfies a threshold value, wherein the threshold value is based on a length of the at least one suggested text portion.

4. The method of claim 1, wherein receiving the at least one second gaze input further comprises: displaying a visual indication, indicating that the at least one suggested text portion will be added to the message.

5-14. (canceled)

15. A system for using augmented or alternative communications (AAC) system including an eye tracking device, the system comprising at least one processor programmed or configured to:
receive at least one gaze input from a user of the eye tracking device,
display at least one selected text portion in response to receiving the at least one gaze input, the at least one selected text portion forming a message, wherein the user interface comprises a message window, and wherein the message is displayed in the message window;
generate at least one suggested text portion, the at least one suggested text portion being adaptive to a content of the message;
display the at least one suggested text portion in the message window of the user interface;
receive at least one second gaze input from the user; and
modify the message to add the at least one suggested text portion to the message based on receiving the at least one second gaze input from the user.

16. The system of claim 15, wherein when receiving the at least one second gaze input, the at least one processor is programmed or configured to:
determine a location of the at least one suggested text portion in the message window;
determine a location of the at least one second gaze input;
determine whether the location of the at least one suggested text portion in the message window is the same as the location of the at least one second gaze input; and
verify the at least one second gaze input is a confirmatory input based on determining the location of the at least one suggested text portion in the message window is the same as the location of the gaze input.

17. The system of claim 16, wherein the at least one processor is further programmed or configured to:
determine whether a length of time of the at least one second gaze input satisfies a threshold value, wherein the threshold value is based on a length of the at least one suggested text portion.

18. The system of claim 15, wherein when receiving the at least one second gaze input the at least one processor is further programmed or configured to:
display a visual indication, indicating that the at least one suggested text portion will be added to the message.

19-28. (canceled)

29. A computer program product for using augmented or alternative communications (AAC) system including an eye tracking device, the computer program product comprising at least one non-transitory computer-readable medium including one or more instructions that, when executed by at least one processor, cause the at least one processor to: receive at least one gaze input from a user of the eye tracking device,
display at least one selected text portion in response to receiving the at least one gaze input, the at least one selected text portion forming a message, wherein a user interface comprises a message window, and wherein the message is displayed in the message window;
generate at least one suggested text portion, the at least one suggested text portion being adaptive to a content of the message;
display the at least one suggested text portion in the message window of the user interface;
receive at least one second gaze input from the user; and
modify the message to add the at least one suggested text portion to the message based on receiving the at least one second gaze input from the user.

30. The computer program product of claim 29, wherein when receiving the at least one second gaze input, the one or more instructions cause the at least one processor to:
determine a location of the at least one suggested text portion in the message window;
determine a location of the at least one second gaze input;
determine whether the location of the at least one suggested text portion in the message window is the same as the location of the at least one second gaze input; and
verify the at least one second gaze input is a confirmatory input based on determining the location of the at least one suggested text portion in the message window is the same as the location of the gaze input.

31. The computer program product of claim 30, wherein the one or more instructions further cause the at least one processor to:
determine whether a length of time of the at least one second gaze input satisfies a threshold value, wherein the threshold value is based on a length of the at least one suggested text portion.

32. The computer program product of claim 29, wherein when receiving the at least one second gaze input the one or more instructions further cause the at least one processor to:
display a visual indication, indicating that the at least one suggested text portion will be added to the message.

33-42. (canceled)
